(19) United States
(12) Patent Application Publication
(10) Pub. No.: US 2024/0404164 A1
(43) Pub. Date: Dec. 5, 2024

(54) ANIMATION GENERATION METHOD AND DEVICE, EQUIPMENT AND STORAGE MEDIUM

(71) Applicant: Beijing Zitiao Network Technology Co., Ltd., Beijing (CN)

(72) Inventors: Zixin LIU, Beijing (CN); Shurong LI, Beijing (CN)

(21) Appl. No.: 18/798,678

(22) Filed: Aug. 8, 2024

Related U.S. Application Data
(63) Continuation of application No. PCT/CN2023/074556, filed on Feb. 6, 2023.

(30) Foreign Application Priority Data
Feb. 8, 2022 (CN) 202210119451.1

(51) Int. Cl. G06T 13/80

(52) U.S. Cl. CPC G06T 13/80; G06T 2200/24

(57) ABSTRACT

The present disclosure provides an animation generation method and device, an equipment and a storage medium. The animation generation method includes: determining a material corresponding to at least one object element of a target virtual object; and in response to an animation generation operation for the target virtual object, generating at least one animation corresponding to the target virtual object, based on the material corresponding to the at least one object element.

### CROSS-REFERENCE TO RELATED APPLICATIONS

The present disclosure is a continuation of PCT/CN2023/074556, filed on Feb. 6, 2023, which claims priority to Chinese Patent Application No. 202210119451.1, filed on Feb. 8, 2022, the disclosures of which are incorporated into this disclosure by reference in their entireties.

### TECHNICAL FIELD

The present disclosure relates to the field of data processing, and in particular, to an animation generation method and apparatus, a device, and a storage medium.

### BACKGROUND

With the continuous development of computer technologies, users have more and more diversified requirements on playing methods supported by virtual character generation application programs. Therefore, how to enrich playing methods of the virtual character generation application programs to meet the users' diversified requirements on the playing methods, is a technical problem to be solved urgently at present.

### SUMMARY

In a first aspect, the present disclosure provides an animation generation method, comprising:
determining a material corresponding to at least one object element of a target virtual object; and
in response to an animation generation operation for the target virtual object, generating at least one animation corresponding to the target virtual object, based on the material corresponding to the at least one object element.

In a second aspect, the present disclosure provides an animation generation apparatus, comprising:
a first determination module configured to, determine a material corresponding to at least one object element of a target virtual object; and
a first generation module configured to, in response to an animation generation operation for the target virtual object, generate at least one animation corresponding to the target virtual object, based on the material corresponding to the at least one object element.

In a third aspect, the present disclosure provides a computer-readable storage medium having stored therein instructions that, when run on a terminal device, cause the terminal device to implement the above-mentioned method.

In a fourth aspect, the present disclosure provides a device comprising:
a memory; and
a processor coupled to the memory, the processor configured to perform the above-described method based on instructions stored in the memory.

In a fifth aspect, the present disclosure provides a computer program product comprising a computer program/instructions which, when executed by a processor, implement the above-described method.

In a sixth aspect, the present disclosure provides a computer program comprising instructions which, when executed by a processor, cause the processor to perform the above-mentioned animation generation method.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

In order to more clearly illustrate the embodiments of the present disclosure or technical solutions in the related art, the drawings used in the description of the embodiments or the related art will be briefly described below, and it is obvious for those skilled in the art to obtain other drawings without creative labor.

FIG. 1 is a flow diagram of an animation generation method according to some embodiments of the present disclosure;

FIG. 2 is a schematic diagram of a material selection interface of a target virtual object according to some embodiments of the present disclosure;

FIG. 3 is a schematic diagram of an image display interface according to some embodiments of the present disclosure;

FIG. 4 is a schematic diagram of an animation display interface according to some embodiments of the present disclosure;

FIG. 5 is a schematic structural diagram of an animation generation apparatus according to some embodiments of the present disclosure;

FIG. 6 is a schematic structural diagram of an animation generation device according to some embodiments of the present disclosure.

### DETAILED DESCRIPTION

In order that the above objects, features and advantages of the present disclosure may be more clearly understood, solutions of the present disclosure will be further described below. It should be noted that, without conflict, the embodiments of the present disclosure and features in the embodiments may be combined with each other.

In the following description, numerous specific details are set forth in order to provide a thorough understanding of the present disclosure, but the present disclosure may be practiced otherwise than as described herein; it is to be understood that the embodiments disclosed in the specification are only a few embodiments of the present disclosure, and not all embodiments.

How to enrich playing methods of the virtual character generation application programs to meet diversified requirements on the playing methods of users, is a technical problem to be solved urgently at present.

In order to solve the technical problem, the present disclosure provides an animation generating method, capable of generating animation of a target virtual object based on a material corresponding to an object element of the target virtual object, enriching playing methods of the virtual character generation application programs, and improving user experience. An animation comprises, for example, an emoji animation.

A virtual character generator is a playing method in which multiple sets of selectable materials provided by a platform or a creator on the platform and corresponding to multiple parts, are self-selected and configured by other users, to generate favorite images. A user can use the virtual character generator to generate an image of his favorite virtual character as an avatar, a wallpaper, or the like.

However, the current virtual character generators can provide few playing methods, mostly static images, and have limited playability and interest. Therefore, some embodiments of the present disclosure provides an animation generation method, capable of generating animation of a virtual character based on materials available in the virtual character generator.

Specifically, in the animation generation method according to some embodiments of the present disclosure, a material corresponding to at least one object element of a target virtual object is firstly determined, and then, when an animation generation operation for the target virtual object is received, at least one animation corresponding to the target virtual object is generated based on the material corresponding to the at least one object element. Therefore, some embodiments of the present application can generate the animation of the target virtual object based on the material of the object element of the target virtual object, enriching the playing methods of the virtual character generation application programs and improving user experience.

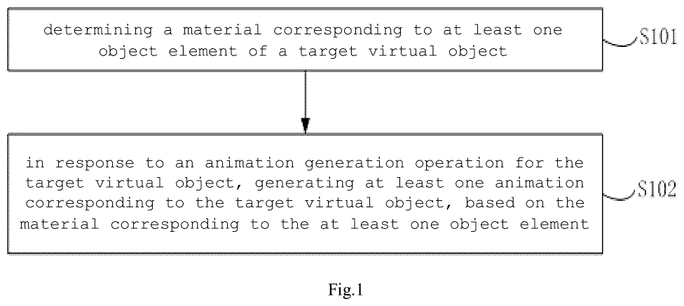

Based on this, some embodiments of the present disclosure provides an animation generation method; with reference to FIG. 1, a flow diagram of an animation generation method according to some embodiments of the present disclosure is provided, comprising: S101: determining a material corresponding to at least one object element of a target virtual object.

In some embodiments of the present disclosure, the target virtual object may be a virtual character, such as an animation character. The object element may be a part of the virtual character, such as hair, clothing, etc. The material corresponding to the object element may be an image drawn by a creator, for example, different hair style materials corresponding to a hair element, different clothes materials corresponding to a clothes element, and so on.

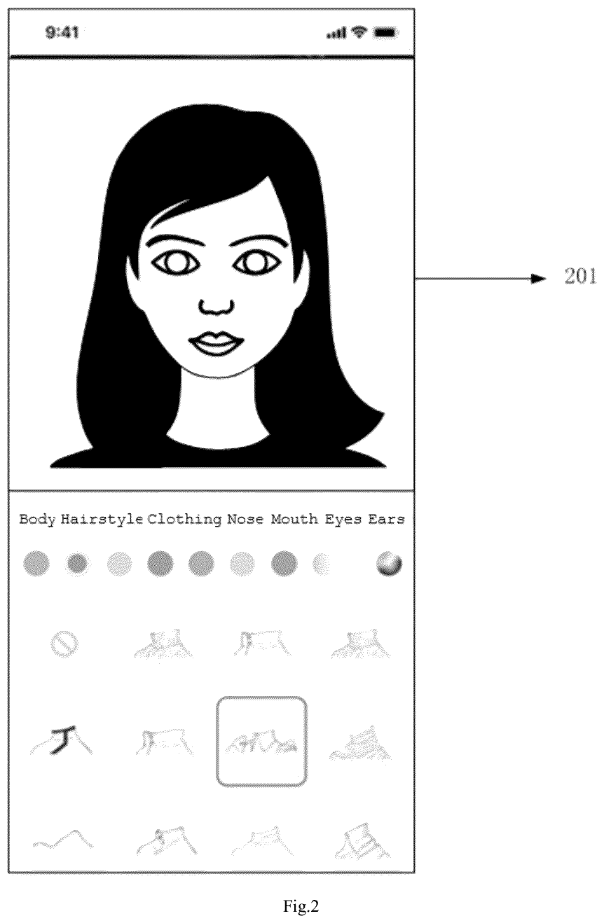

In some embodiments, the target virtual object may be any virtual object determined from a plurality of virtual objects, and specifically, a material corresponding to at least one object element of the target virtual object may be determined on a material selection interface of the target virtual object. As shown in FIG. 2, it is a schematic diagram of a material selection interface of a target virtual object according to some embodiments of the present disclosure, wherein, in a preview window 201 of the material selection interface, a preview effect of the target virtual object is displayed based on the material corresponding to at least one object element determined for the target virtual object.

In practical applications, on a material selection interface of the target virtual object, in response to a material selection operation for an object element of the target virtual object, a material corresponding to the object element is determined. Specifically, for any object element of the target virtual object, a material corresponding to the object element may be determined by selecting any of selectable materials corresponding to the object element.

In some embodiments, a random control may be provided on the material selection interface of the target virtual object, and when a trigger operation for the random control is received, a corresponding material may be randomly determined for each object element of the target virtual object.

S102: in response to an animation generation operation for the target virtual object, generating at least one animation corresponding to the target virtual object, based on the material corresponding to the at least one object element.

In some embodiments of the present disclosure, after determining the material corresponding to the at least one object element of the target virtual object, if an animation generation operation for the target virtual object is received, at least one animation corresponding to the target virtual object may be generated based on the determined material corresponding to the at least one object element.

In some embodiments, a user may trigger an animation generation operation for the target virtual object, by clicking a preset control on a material selection interface of the target virtual object. The preset control may be a save control on the material selection interface shown in FIG. 2.

In addition, the animation of the target virtual object can be generated based on the material corresponding to the object element, in some embodiments of the present disclosure. In some embodiments, the animation of the target virtual object may be generated based on the material corresponding to the object element, using a drawing rendering technique (e.g., live2D technique) of electronic games.

In practical applications, the determined materials of each object element of the target virtual object can be input into a Live2D model, which are processed by the Live2D model, to generate the animation of the target virtual object.

In some embodiments, one or more animations corresponding to the target virtual object may be generated based on the determined material corresponding to the object element of the target virtual object. In case that a plurality of animations corresponding to the target virtual object are generated, each animation may correspond to different emojis of the target virtual object.

In some embodiments, different animations correspond to different emojis of the target virtual object.

In some embodiments, on the material selection interface, in response to an image generation operation for the target virtual object, an image corresponding to the target virtual object is generated based on the determined material corresponding to the at least one object element. The material corresponding to the at least one object element is displayed in the generated image. For example, the generated image shows materials selected by the user for object elements such as hair style, clothes, nose, and the like. In addition, the generated image may be used as avatar, wallpaper, or the like.

In some embodiments, in response to a request for setting an avatar triggered by the user for any of one or more animations corresponding to the target virtual object, the animation is set as the avatar of a target home page, wherein the target home page can be a page corresponding to the request, and is a page for setting the avatar, selected by the user. In addition, in response to the request for setting an avatar triggered by the user for any of one or more animations corresponding to the target virtual object, the animations can be set as the avatar of the target home page according to a display mode corresponding to the request. The request carries display modes of the animations, and the display modes comprise a display sequence of the animations, a display duration of each animation and the like.

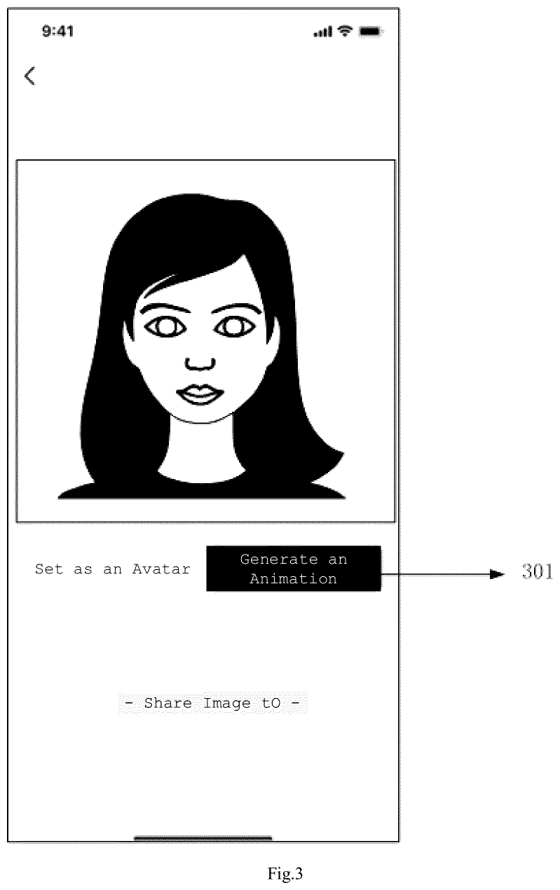

In some embodiments, when the user clicks the save control in FIG. 2, an image generation operation for the target virtual object may be triggered, and based on the determined material corresponding to the at least one object element, an image corresponding to the target virtual object is generated, and the image may be displayed on the image display interface. As shown in FIG. 3, it is a schematic diagram of an image display interface according to some embodiments of the present disclosure. The image display interface is provided with an generation control 301.

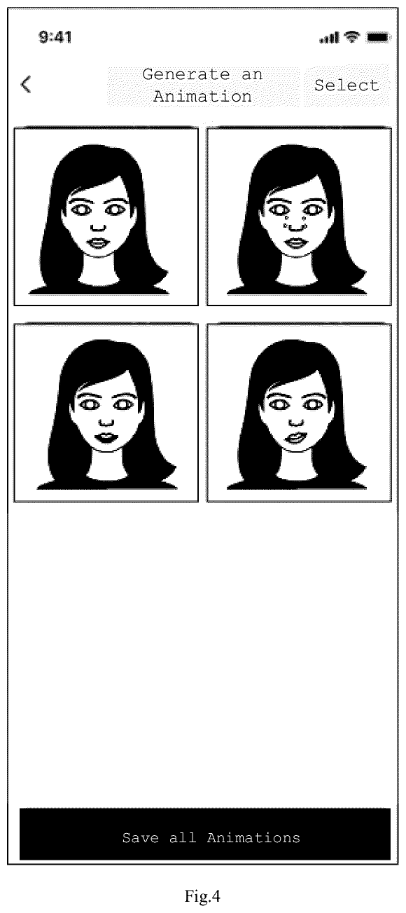

In practical applications, a user may trigger the animation generation operation for the target virtual object by clicking the generation control in FIG. 3, and then generate at least one animation corresponding to the target virtual object based on the determined material corresponding to the at least one object element. The generated at least one animation can be displayed on an animation display interface, as shown in FIG. 4, which is a schematic diagram of an animation display interface according to some embodiments of the present disclosure.

On the animation display interface in FIG. 4, one or more animations in the generated at least one animation may be saved, or an operation such as zoom-in and share may be triggered for any animation. That is to say, the animation generation method comprises at least one of: in response to a zoom-in operation for the at least one animation corresponding to the target virtual object, displaying the at least one animation corresponding to the target virtual object in a zoom-in manner; in response to a share operation for the at least one animation corresponding to the target virtual object, sharing the at least one animation corresponding to the target virtual object; or in response to a save operation for the at least one animation corresponding to the target virtual object, saving the at least one animation corresponding to the target virtual object.

In the animation generation method according to some embodiments of the present disclosure, a material corresponding to at least one object element of a target virtual object is firstly determined, and then, when an animation generating operation for the target virtual object is received, at least one animation corresponding to the target virtual object is generated based on the material corresponding to the at least one object element. Therefore, some embodiments of the present disclosure can generate the animation of the target virtual object based on the material of the object element of the target virtual object, enriching playing methods of the virtual character generation application programs and improving user experience.

The animation generation method according to some embodiments of the present disclosure can not only provide an animation generating function of the target virtual object for a user, but also provide functions of uploading or shooting materials for a creator, editing layers of object elements and the like.

Specifically, at least one material may be uploaded or shot for an object element of the target virtual object. For example, a creator may upload or shoot at least one hair style material for a hair element of the target virtual object.

In some embodiments, in responds to that the user is a creator, a material upload entry may be provided on the material selection interface of the target virtual object, and at least one material may be uploaded or shot for the object element based on the material upload entry.

In some embodiments, in responds to that the user is a creator, a layer management control may be further provided on the material selection interface of the target virtual object, and the user may trigger a layer editing operation for a target object element among the at least one object element of the target virtual object by clicking the layer management control. The target object element may be any of a plurality of object elements of the target virtual object, for example, an object element such as hair or clothes.

Specifically, when a layer editing trigger operation for the target object element of the target virtual object is received, a layer editing interface corresponding to the target object element is displayed. On the layer editing interface, a layer classification can be determined for the target object element, wherein the layer classification corresponds to a display level identifier, and the display level identifier represents a display level of the material of the target object element in the animation of the target virtual object.

For example, the layer classification may comprise a hair layer, a clothes layer, and the like, and the user determines the display level of the target object element among the animation of the target virtual object by selecting the layer classification for the target object element.

In some embodiments, a correspondence between the layer classification and the display level identifier may be predetermined. For example, the display level identifier corresponding to the hair layer is 1, the display level identifier corresponding to the clothes layer is 3, and it can be determined that the hair layer is displayed above the clothes layer according to an ascending order of the display level identifiers. By determining the layer classification for the target object element, the display level of the material corresponding to the target object element among the animation of the target virtual object can be determined. For example, assuming that the layer classification determined for the hair object element is a hair layer and the layer classification determined for the clothes object element is a clothes layer, the hair of the target virtual object is displayed above the clothes in the animation of the target virtual object. In some embodiments of the present disclosure, a creator may determine a display level for each object element of the target virtual object based on creation requirements, improving creation experience of the creator.

In practical applications, when receiving an animation generating operation for the target virtual object, at least one animation corresponding to the target virtual object is generated based on the determined material corresponding to the at least one object element and a display level (layer) identifier corresponding to each object element. The materials of each object element are displayed on the animation based on the display level identifier.

The animation generation method according to some embodiments of the present disclosure can generate the animation of the target virtual object based on the material of the object element of the target virtual object, enriching the playing methods of the virtual character generation application programs, and improving the user experience. In addition, some embodiments of the present disclosure can also provide for the creator, a function of determining a display level for the material corresponding to the object element of the target virtual object, meeting the creation requirements of the creator.

In some embodiments, determining a material corresponding to at least one object element of a target virtual object, comprises: displaying a material display page corresponding to an object element (such as a target object element of at least one target virtual object), wherein the material display page displays at least one material; and in response to a selection operation for a target material among the at least one material, determining the selected material as the material corresponding to the at least one object element of the target virtual object.

Furthermore, in some embodiments, the animation generation method further comprises: displaying a material editing page in response to the selection operation for the target material among the at least one material, modifying the target material in response to an editing operation on the material editing page, and determining the modified target material as the material corresponding to the at least one object element of the target virtual object.

In some embodiments, the animation generation method further comprises: in response to a custom animation setting operation, displaying a custom animation setting page, after determining the material corresponding to the at least one object element of the target virtual object, wherein the material corresponding to the at least one object element is displayed on the custom animation setting page; in response to a trigger (e. g. drag deformation, shift, rotation, etc.) operation for the material corresponding to the at least one object element, determining motion information or deformation information corresponding to the trigger operation. Correspondingly, the in response to an animation generation operation for the target virtual object, generating at least one animation corresponding to the target virtual object, based on the material corresponding to the at least one object element comprises: in response to the animation generation operation for the target virtual object, generating the at least one animation corresponding to the target virtual object according to the motion information or the deformation information, based on the material corresponding to the at least one object element. Specifically, the motion information comprises starting position information and ending position information of the material corresponding to the at least one object element. According to the shift operation, the starting position information (a material position before the shift) and ending position information (a material position after the shift) of the material can be determined, a motion track of the material is generated according to the starting position information and the ending position information, and the animation is generated according to the motion track. Therefore, the interaction playing methods are enriched, and diversified requirements are met.

In addition, in response to the animation generation operation for the target virtual object, at least one animation corresponding to the target virtual object can be generated based on the material corresponding to the at least one object element, according to a preset or specified generation mode.

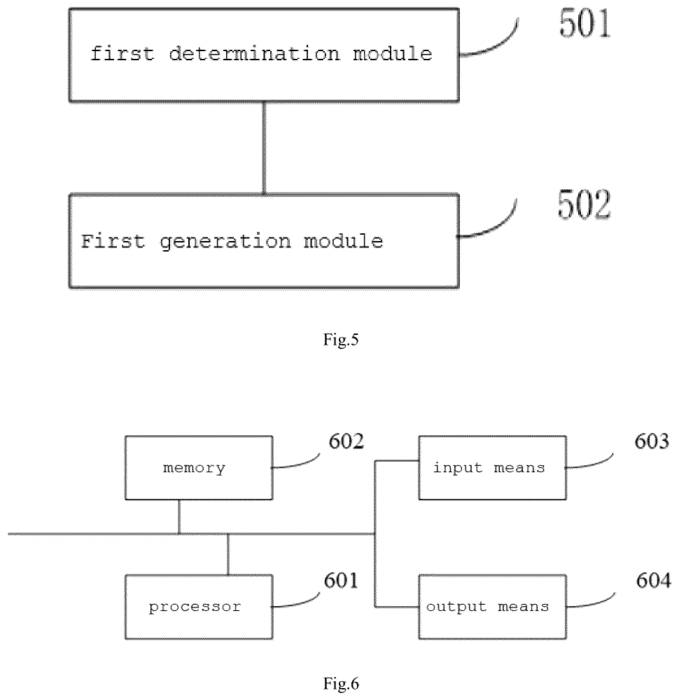

Based on the same inventive concept as the above embodiments, some embodiments of the present disclosure further provide an animation generation apparatus; with reference to FIG. 5, it is a schematic structural diagram of an animation generation apparatus according to some embodiments of the present disclosure, comprising:
a first determination module 501, configured to determine a material corresponding to at least one object element of a target virtual object;
a first generation module 502, configured to, in response to an animation generating operation for the target virtual object, generate at least one animation corresponding to the target virtual object, based on the material corresponding to the at least one object element.

In some embodiments, the first determination module is specifically configured to:
on a material selection interface of the target virtual object, in response to a material selection operation for the object element of the target virtual object, determine the material corresponding to the object element.

In some embodiments, the animation generation apparatus further comprises:
a second generation module, configured to, in response to an image generation operation for the target virtual object, generate an image corresponding to the target virtual object based on the material corresponding to the at least one object element; wherein, the material corresponding to the at least one object element is displayed in the image;
correspondingly, the first generation module is specifically configured to:
in response to the animation generation operation for the target virtual object on a display page of the image, generate the at least one animation corresponding to the target virtual object, based on the material corresponding to the at least one object element.

In some embodiments, the animation generation apparatus further comprises:
a receiving module, configured to receive at least one material uploaded or shot for the at least one object element of the target virtual object;
a first display module, configured to, in response to a layer editing trigger operation for a target object element of the target virtual object, display a layer editing interface corresponding to the target object element;
a second determination module, configured to determine a layer classification for the target object element based on the layer editing interface; wherein, the layer classification has a corresponding display level identifier, for representing a display level of the material of the target object element among the animation of the target virtual object;
correspondingly, the first generation module is specifically configured to:
in response to the animation generation operation for the target virtual object, generate the at least one animation corresponding to the target virtual object, based on the material corresponding to the at least one object element and the display level identifier.

In some embodiments, the at least one animation corresponds to different emojis of the target virtual object.

In some embodiments, the first determination module comprises:
a display sub-module, configured to display a material display page corresponding to a target object element among the at least one object element of the target virtual object, wherein at least one material is displayed in the material display page; and
a determination sub-module, configured to, in response to a selection operation for a target material among the at least one material, determine the target material as the material corresponding to the target object element.

In some embodiments, the first determination sub-module comprises:
a display sub-module, configured to, in response to the selection operation for the target material among the at least one material, display a material editing page; and
an editing sub-module, configured to, in response to an editing operation on the material editing page, edit the target material and determine the edited target material as the material corresponding to the target object element.

In some embodiments, the animation generation apparatus further comprises:
a second display module, configured to, in response to a custom animation setting operation for the target virtual object, display a custom animation setting page, on which the material corresponding to the at least one object element of the target virtual object is displayed;
an acquisition module, configured to, in response to a trigger operation for the material corresponding to the at least one object element, acquire motion or deformation information corresponding to the trigger operation;
correspondingly, the first generation module is specifically configured to:
in response to the animation generation operation for the target virtual object, generate the at least one animation corresponding to the target virtual object according to the motion or deformation information, based on the material corresponding to the at least one object element.

In the animation generation apparatus according to some embodiments of the present disclosure, firstly, a material corresponding to at least one object element of a target virtual object is determined, and then, when an animation generating operation for the target virtual object is received, at least one animation corresponding to the target virtual object is generated based on the material corresponding to the at least one object element. Therefore, some embodiments of the present disclosure can generate the animation of the target virtual object based on the material of the object element of the target virtual object, enriching the playing methods of the virtual character generation application programs, and improving the user experience.

The modules described above may be implemented as software components executing on one or more general-purpose processors, or as hardware such as a programmable logic device and/or application specific integrated circuits that perform certain functions, or combinations thereof. In some embodiments, the modules may be embodied in the form of a software product that may be stored in a non-volatile storage medium comprising instructions that cause a computer device (e.g., a personal computer, server, network device, mobile terminal, etc.) to implement the methods described in some embodiments of the present disclosure. In some embodiments, the modules described above may also be implemented on a single device or may be distributed across multiple devices. The functions of these modules may be combined with each other, or further divided into a plurality of sub-modules.

In addition to the method and apparatus, some embodiments of the present disclosure further provide a computer-readable storage medium, having instructions stored thereon, which, when run on a terminal device, cause the terminal device to implement the animation generation method according to some embodiments of the present disclosure.

Some embodiments of the present disclosure further provide a computer program product comprising a computer program/instructions, that when executed by a processor, implement the animation generation method according to some embodiments of the present disclosure.

Some embodiments of the present disclosure further provide an apparatus, comprising:
a memory; and
a processor coupled to the memory, the processor configured to implement the animation generation method according to some embodiments of the present disclosure, based on instructions stored in the memory.

In addition, some embodiments of the present disclosure further provide an animation generation device, as shown in FIG. 6, comprising: a processor 601, a memory 602, an input means 603, and an output means 604. The number of the processor 601 in the animation generation device may be one or more, and one processor is taken as an example in FIG. 6. In some embodiments of the present disclosure, the processor 601, the memory 602, the input means 603 and the output means 604 may be connected by a bus or in other manners, wherein the connection by the bus is exemplified in FIG. 6.

The memory 602 may be configured to store software programs and modules, and the processor 601 may execute the software programs and modules stored in the memory 602 to perform various functional applications and data processing of the animation generation device. The memory 602 may mainly comprise a program storage area and a data storage area, wherein the program storage area may store an operating system, an application required for at least one function, and the like. Further, the memory 602 may comprise a high speed random access memory, and may also comprise a non-volatile memory, such as at least one magnetic disk storage device, flash memory device, or other volatile solid state storage devices. The input means 603 may be used to receive input numeric or character information and to generate signal inputs related to user settings and function controls of the animation generation device.

Specifically, in this embodiment, the processor 601 loads an executable file corresponding to a process of one or more applications into the memory 602 according to the following instructions, and the processor 601 runs the application stored in the memory 602, thereby implementing various functions of the above-described animation generating device.

It is noted that, relational terms such as “first” and “second” and the like herein, are used only to distinguish one entity or action from another entity or action, without necessarily requiring or implying any actual such relationship or order between such entities or actions. Also, the terms “comprise”, “include” or any other variation thereof, are intended to cover a non-exclusive inclusion, such that a process, method, article, or apparatus that comprises a list of elements does not include only those elements but may include other elements not expressly listed or inherent to such process, method, article, or apparatus. Without further limitation, an element defined by the phrase “comprising an . . . ” does not exclude the presence of other identical elements in the process, method, article, or apparatus that comprises the element.

The above only describes particular embodiments of the present disclosure, so as to enable those skilled in the art to understand or implement the present disclosure. Various modifications to these embodiments will be obvious to those skilled in the art, and the generic principles defined herein may be applied to other embodiments without departing from the spirit or scope of the present disclosure. Thus, the present disclosure is not intended to be limited to the embodiments shown herein but is to be accorded the widest scope consistent with the principles and novel features disclosed herein.

What is claimed is:

1. An animation generation method, comprising:
determining a material corresponding to at least one object element of a target virtual object; and
in response to an animation generation operation for the target virtual object, generating at least one animation corresponding to the target virtual object, based on the material corresponding to the at least one object element.

2. The animation generation method according to claim 1, wherein the determining the material corresponding to the at least one object element of the target virtual object comprises:
on a material selection interface of the target virtual object, in response to a material selection operation for the at least one object element of the target virtual object, determining the material corresponding to the at least one object element.

3. The animation generation method according to claim 1, further comprising:
in response to an image generation operation for the target virtual object, generating an image corresponding to the target virtual object based on the material corresponding to the at least one object element, before the in response to the animation generation operation for the target virtual object, generating the at least one animation corresponding to the target based on the material corresponding to the at least one object element virtual object, wherein the material corresponding to the at least one object element is displayed in the image;
wherein the in response to the animation generation operation for the target virtual object, generating the at least one animation corresponding to the target virtual object, based on the material corresponding to the at least one object element, comprises:
in response to the animation generation operation for the target virtual object on a display page of the image, generating the at least one animation corresponding to the target virtual object, based on the material corresponding to the at least one object element.

4. The animation generation method according to claim 1, further comprising:
in response to a layer editing trigger operation for a target object element among the at least object element of the target virtual object, displaying a layer editing interface corresponding to the target object element;
determining a layer classification corresponding to the target object element based on the layer editing interface, wherein the layer classification corresponds to a display level identifier, and the display level identifier represents a display level of the material of the target object element among the animation of the target virtual object;
wherein the in response to the animation generation operation for the target virtual object, generating the at least one animation corresponding to the target virtual object, based on the material corresponding to the at least one object element, comprises:
in response to the animation generation operation for the target virtual object, generating the at least one animation corresponding to the target virtual object, based on the material corresponding to the at least one object element and the display level identifier.

5. The animation generation method according to claim 1, wherein the determining the material corresponding to the at least one object element of the target virtual object comprises:
displaying a material display page corresponding to a target object element among the at least one object element of the target virtual object, wherein at least one material is displayed in the material display page; and
in response to a selection operation for a target material among the at least one material, determining the target material as the material corresponding to the target object element.

6. The animation generation method according to claim 5, wherein the in response to the selection operation for the target material among the at least one material, determining the target material as the material corresponding to the target object element, comprises:
in response to the selection operation for the target material among the at least one material, displaying a material editing page; and
in response to an editing operation on the material editing page, editing the target material and determining the edited target material as the material corresponding to the target object element.

7. The animation generation method according to claim 1, further comprising:
in response to a custom animation setting operation for the target virtual object, displaying a custom animation setting page, after the determining the material corresponding to the at least one object element of the target virtual object, wherein the material corresponding to the at least one object element of the target virtual object is displayed on the custom animation setting page; and
in response to a trigger operation for the material corresponding to the at least one object element, acquiring motion or deformation information corresponding to the trigger operation;
wherein the in response to the animation generation operation for the target virtual object, generating the at least one animation corresponding to the target virtual object, based on the material corresponding to the at least one object element, comprises:
in response to the animation generation operation for the target virtual object, generating the at least one animation corresponding to the target virtual object according to the motion or deformation information, based on the material corresponding to the at least one object element.

8. The animation generation method according to claim 7, wherein the motion information comprises starting position information and ending position information of the material corresponding to the at least one object element.

9. The animation generation method according to claim 1, further comprising:
displaying a preview effect of the target virtual object based on the material corresponding to the at least one object element.

10. The animation generation method according to claim 1, wherein the in response to an animation generation operation for the target virtual object, generating the at least one animation corresponding to the target virtual object, based on the material corresponding to the at least one object element, comprises:
in response to the animation generation operation for the target virtual object, generating the at least one animation corresponding to the target virtual object according to a specified generation mode, based on the material corresponding to the at least one object element.

11. The animation generation method according to claim 1, further comprising:
receiving at least one material uploaded or shot for the at least one object element of the target virtual object.

12. The animation generation method according to claim 1, further comprising at least one of:
in response to a zoom-in operation for the at least one animation corresponding to the target virtual object, displaying the at least one animation corresponding to the target virtual object in a zoom-in manner;
in response to a share operation for the at least one animation corresponding to the target virtual object, sharing the at least one animation corresponding to the target virtual object; or
in response to a save operation for the at least one animation corresponding to the target virtual object, saving the at least one animation corresponding to the target virtual object.

13. A non-transitory computer-readable storage medium having stored therein instructions that, when run on a terminal device, cause the terminal device to implement the animation generation method, comprising:
determining a material corresponding to at least one object element of a target virtual object; and
in response to an animation generation operation for the target virtual object, generating at least one animation corresponding to the target virtual object, based on the material corresponding to the at least one object element.

14. A device comprising:
a memory; and
a processor coupled to the memory, the processor is configured to perform the animation generation method, comprising:
determining a material corresponding to at least one object element of a target virtual object; and
in response to an animation generation operation for the target virtual object, generating at least one animation corresponding to the target virtual object, based on the material corresponding to the at least one object element.

15. The non-transitory computer-readable storage medium according to claim 13, wherein the determining the material corresponding to the at least one object element of the target virtual object comprises:
on a material selection interface of the target virtual object, in response to a material selection operation for the at least one object element of the target virtual object, determining the material corresponding to the at least one object element.

16. The non-transitory computer-readable storage medium according to claim 13, wherein the animation generation method further comprising:
in response to an image generation operation for the target virtual object, generating an image corresponding to the target virtual object based on the material corresponding to the at least one object element, before the in response to the animation generation operation for the target virtual object, generating the at least one animation corresponding to the target based on the material corresponding to the at least one object element virtual object, wherein the material corresponding to the at least one object element is displayed in the image;
wherein the in response to the animation generation operation for the target virtual object, generating the at least one animation corresponding to the target virtual object, based on the material corresponding to the at least one object element, comprises:
in response to the animation generation operation for the target virtual object on a display page of the image, generating the at least one animation corresponding to the target virtual object, based on the material corresponding to the at least one object element.

17. The device according to claim 14, wherein the determining the material corresponding to the at least one object element of the target virtual object comprises:
on a material selection interface of the target virtual object, in response to a material selection operation for the at least one object element of the target virtual object, determining the material corresponding to the at least one object element.

18. The device according to claim 14, wherein the animation generation method further comprising:
in response to an image generation operation for the target virtual object, generating an image corresponding to the target virtual object based on the material corresponding to the at least one object element, before the in response to the animation generation operation for the target virtual object, generating the at least one animation corresponding to the target based on the material corresponding to the at least one object element virtual object, wherein the material corresponding to the at least one object element is displayed in the image;
wherein the in response to the animation generation operation for the target virtual object, generating the at least one animation corresponding to the target virtual object, based on the material corresponding to the at least one object element, comprises:
in response to the animation generation operation for the target virtual object on a display page of the image, generating the at least one animation corresponding to the target virtual object, based on the material corresponding to the at least one object element.
